(19) United States
(12) Patent Application Publication
(10) Pub. No.: US 2008/0267683 A1
(43) Pub. Date: Oct. 30, 2008

(54) IPv6 keypad

(75) Inventor: Dennis Peper, Amsterdam (NL)

Correspondence Address: Dennis Peper, 5 Bardia Street, Belmont 0622, Auckland, 0622, NZ

(73) Assignee: Dennis Peper, Amsterdam (NL)

(21) Appl. No.: 11/790,506

(22) Filed: Apr. 26, 2007

(51) Int. Cl. B41J 5/10

(52) U.S. Cl. 400/489

(57) ABSTRACT

With the layout of today's computer keyboards, inputting IPv6 addresses and subnets is difficult because of the location of required characters. My invention is a computer keypad that includes all the characters required for the input of IPv6 addresses and subnets. This allows the easy input of IPv6 addresses and subnets with just one hand. Double colon (::), enter or tab keys may be included as well to facilitate input. A period (.) for IPv4 addresses is also included for backwards compatibility.

### BACKGROUND

The vast majority of data transferred on the Internet is transported using IP (Internet Protocol). In order to transfer data using IP, Internet attached devices must be assigned an IP address. The IP protocol most widely in use now is IPv4 (Internet Protocol version 4[1]). IPv4 addresses are 32 bits long. For ease of use they are notated as 4 decimal numbers ranging from 0 to 255 and separated with a period (.). This is known as dot-decimal notation.

Examples of IPv4 addresses in dot-decimal notation:
127.0.0.1
192.168.2.50
10.230.47.128

When notating subnets, sometimes a subnet mask must be written. This is done using the forward slash character followed by the number of bits. For example:

192.168.0.0/16
10.5.1.0/24

Due to the large number of IP capable devices attached to the internet, we will at some stage run out of IPv4 addresses to assign. Aside from this there are also other improvements that can be made to IPv4. To improve on IPv4, IPv6 (Internet Protocol version 6) has been developed [2][3].

IPv6 addresses are 128 bits long and are notated using up to 32 hexadecimal characters (a, b, c, d, e, f, 0, 1, 2, 3, 4, 5, 6, 7, 8, 9) and the colon (:) character. IPv6 addresses may also include two colons together, a “double colon” (::).

IPv6 address examples:
23ed:d4b8:1932::de98
1243:1c3::32d8
2066:f99e::2199:ac22
9912:9bc5:5290:eebb:a4b1:ffff:ffff:ffff
3ccf:0000:0000:ac17:2199:0000:0000:ac22
1e7c:1a9b:92ed:10ee:34b9:aa23:ce29:3c3e

As with IPv4, when notating an IPv6 subnet you can specify the subnet mask using a forward slash (/), followed by the number of bits. For example:

3ccf:ac17:5290::/48
2001:0db8:5290:12ff:ab34::/80

Sometimes IPv4 addresses are integrated within the IPv6 address notation, which require a period (.). This is known as an “IPv4 mapped IPv6 address”.

Below are examples of IPv4 mapped IPv6 addresses:
::ffff:192.0.2.128
::ffff:10.20.0.201

### BRIEF SUMMARY OF THE INVENTION

Located on most standard keyboards is a numeric keypad. Entering IPv4 addresses and subnets using the keypad is very easy and fast. A person can enter these with the keypad using just one hand.

IPv6 requires additional characters over IPv4. The additional characters are: a, b, c, d, e, f, :

These characters are located in the “main area” of the keyboard, and not within the keypad. They are far apart and are not easily accessible with one hand. Also, to type a colon you must use the shift key. Because of these facts, typing in an IPv6 address or subnet is more difficult and slower than typing in an IPv4 address or subnet. You can not type the entire address with just one hand, which is easier and faster than using two hands.

My invention is a keypad that contains all the characters required for IPv6. This makes it as easy and fast to type IPv6 addresses and subnets as it is with IPv4.

My keypad also contains a forward slash for the entering of subnet masks and a period for backwards compatibility with IPv4.

Some IPv6 addresses contain two colons in a row (::). My IPv6 keypad also includes a key which enters two colons at once. This key may only be included on some models depending on usability studies and market demand.

### BRIEF DESCRIPTION OF DRAWINGS

Note that not all keys or characters that appear on most keyboards are displayed in the drawings. Also, this document refers to characters in lowercase, however usually the characters printed on keyboard keys are uppercase (as shown in the diagrams).

FIG. 1a: Standard keyboard, the area known as the keypad is shown within the dotted line. The remaining area to the left is the “main area” of the keyboard.

FIG. 1b: Standard keypad, separated from keyboard.

FIG. 2: IPv6 keypad which is most similar to standard keypad.

FIG. 3: IPv6 keypad which contains double colon and tab keys.

FIG. 4: IPv6 keypad with an alternative layout of the letter keys.

FIG. 5a: IPv6 keypad with layout from FIG. 2 within a larger keyboard. The IPv6 keypad is shown within the dotted line.

FIG. 5b: IPv6 keypad with layout from FIG. 4 within a larger keyboard. The IPv6 keypad is shown within the dotted line.

FIG. 6: IPv6 keypad from FIG. 2 with memory keys.

### DETAILED DESCRIPTION OF THE INVENTION

People working in the IT (Information Technology) field must type IP addresses and subnets into their computers many times on a daily basis. The input of IPv4 addresses and subnets is very simple using standard computer keyboards, for example the common 101 key keyboard or similar.

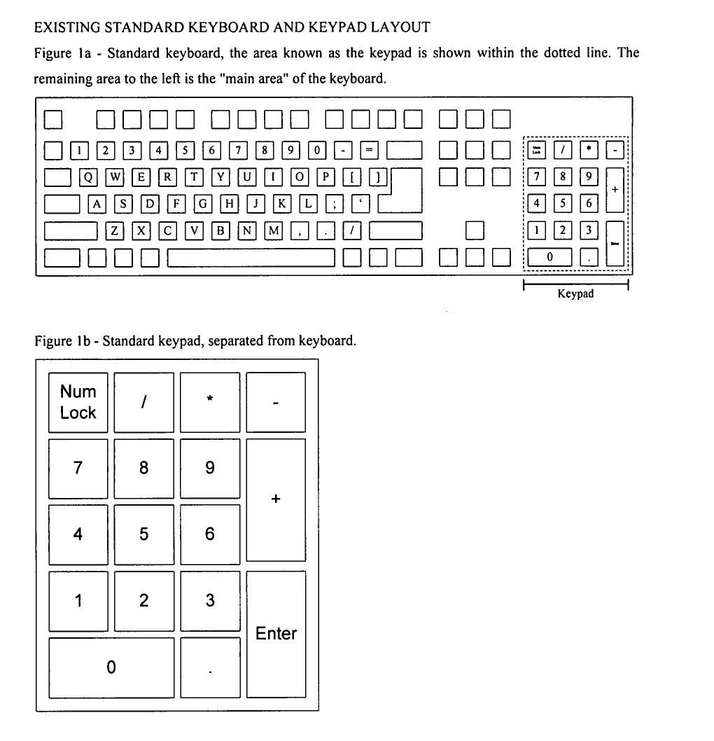

Most keyboards have a numeric keypad located on the right hand side which contains all characters required to input an IPv4 address or subnet: 0 to 9, period and forward slash. Using the numeric keypad, the person can input IPv4 addresses and subnets quickly and easily using just their right hand. FIG. 1a shows the layout of a standard keyboard. The area contained within the dotted line is the keypad.

A keypad can also be separated from the keyboard (FIG. 1b). This is useful for people who wish to reposition the keypad for comfort, or wish to add a keypad to a keyboard without a keypad, for example a laptop keyboard.

IPv6 addresses and subnet masks require more characters to enter them than IPv4 addresses. Also, IPv6 addresses use colons, whereas IPv4 addresses do not.

Characters required to enter an IPv6 address or subnet mask, comma separated: a, b, c, d, e, f, 0, 1, 2, 3, 4, 5, 6, 7, 8, 9, :, /
These characters are located in the main area on the keyboard, and not within the keypad area: a, b, c, d, e, f, :

Entering IPv6 addresses or subnets using a standard keyboard is far more difficult than entering IPv4 addresses and subnets. The characters required to enter IPv6 addresses and subnets are spread out over the keyboard in both the keypad and main areas. To type a colon on a standard keyboard you must use the shift key, which is more work compared to just pressing a key on its own. Using just the keypad on a standard keyboard, you can not enter an IPv6 address.

To type an IPv6 address or subnet as quickly and easily as an IPv4 address or subnet, all of the required characters must be positioned close to each other. They must be positioned such that a person can type an entire IPv6 address with just one hand, and without using the shift key to type a colon.

My invention is a keypad that has the following characteristics (from here on known as the “IPv6 keypad”):
1. It contains all characters required to type an IPv6 address or subnet, specifically: a, b, c, d, e, f, 0, 1, 2, 3, 4, 5, 6, 7, 8, 9, :, /
2. All characters are close to each other so that they are easily accessible using just one hand.
3. The IPv6 keypad also includes a period for backwards compatibility. This allows for the easy input of IPv4 addresses and subnets and IPv4 mapped IPv6 addresses, in addition to IPv6 addresses and subnets.
4. It contains an enter key. This is useful if an application requires that the enter key is pressed after inputting an IP address.
5. It contains a tab key. This is useful if an application requires that the user changes through fields when entering IP addresses or other details. For example in an IP properties screen the user may need to cycle through IP address, subnet mask, gateway, and DNS server fields.
6. It contains a double colon key (::). Pressing this key enters two colon characters with one key press. This saves the user from pressing the colon key twice when entering certain IPv6 addresses.
7. It contains memory keys which allow the user to save often used IPv6 addresses or subnets (or part there of) for easy repeated input. For example, the user may save the IPv6 subnet of their network so that they do not need to repeatedly type it out.

The layout of the IPv6 keypad could be in any of a number of ways. However, characteristics 1, 2 and 3 are always adhered to—the characters required to enter an IPv6 address or subnet mask are all included, all characters must be close together (i.e. all are easily accessible with one hand), and a period is included for backwards compatibility. Characteristics 4 to 7 may or may not be included on various models. This will depend on usability studies and market demand.

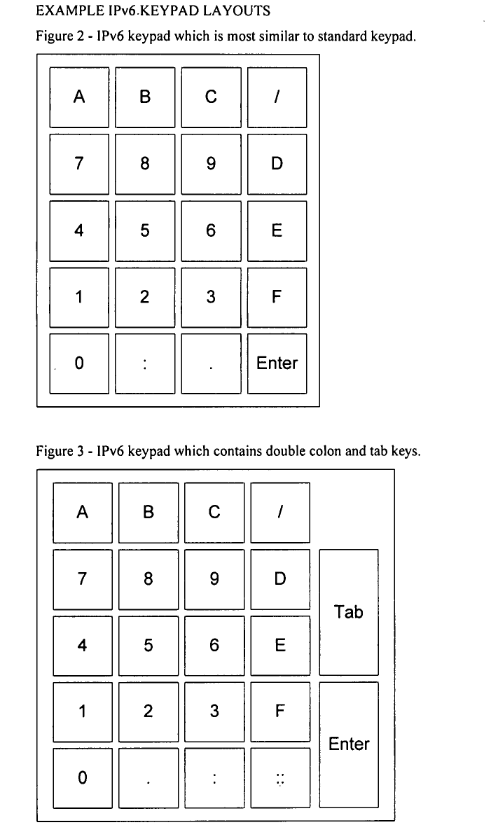

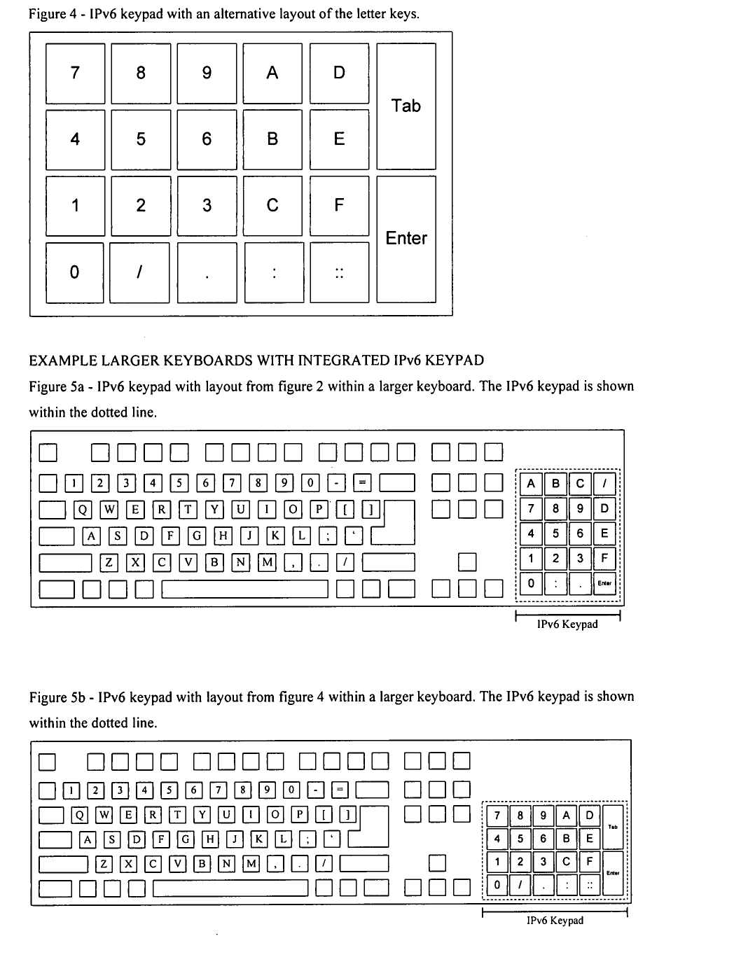

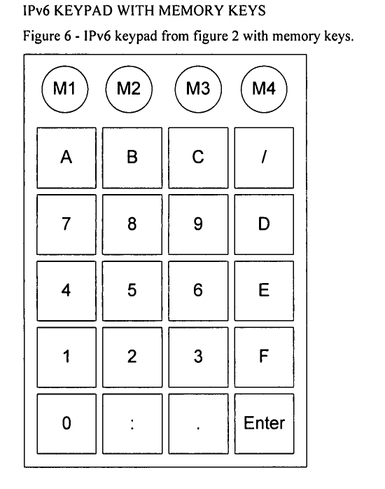

See FIG. 2 for an example layout of an IPv6 keypad. This example is most similar to the existing standard keypad. The numbers are placed in the same position as on the standard keypad for easy adoption by users. Letters required for IPv6 are placed right next to the numbers for easy access. The colon key is placed next to the period key so that either an IPv4 or IPv6 address can be entered. A forward slash key is included for subnet masks and an enter key is included for applications that may require it and backwards compatibility.

As you can see, the number lock (Num Lock), asterisk (*), plus (+) and minus (−) signs are not required for IPv6 addresses and subnets. These keys have been left off the IPv6 keypad to make way for required keys whilst keeping the IPv6 keypad of such size that it is easily accessible with one hand. Optionally, these keys could be included, depending on market research and usability studies.

The example layout in FIG. 3 expands on the layout in FIG. 2 by adding tab and double colon keys. In this example the period key has been moved to below the 2 key so that the colon and double colon can be next to each other to avoid confusion.

FIG. 4 presents an alternative layout to those in FIGS. 2 and 3. In this layout the 6 letters required for IPv6 are placed to the right of the numbers, instead of around the numbers.

All keys on the IPv6 keypad could be rearranged depending the results of studies to find what gives the user the best typing experience. For example, in FIG. 3 the period and colon keys may be swapped so that the period is in its traditional place as on the standard keypad. Research and trials can be carried out to determine which layout will achieve the best user experience.

The IPv6 keypad may be included within a larger keyboard. See FIGS. 5a and 5b for examples.

FIG. 6 shows a variation of the IPv6 keypad in FIG. 2 which contains memory keys. In this case the memory keys are shown named M1, M2, M3 and M4. The user can assign often used strings to these keys. When the user presses a memory key, the stored string is inputted in to the user's current application.

### Additional Applications

There are other applications that require the input of hexadecimal characters and colons outside of IPv6. Examples are Media Access Control (MAC) addresses and fibre channel world wide port names (WWPN).

MAC address examples:

### 00:13:CE:6B:6D:5B

### 00:1B:DB:D5:AB:73

### 00:42:2D:B8:0A:9B

WWPN examples:

### 28:dA:30:F4:8A:E5:87:12

### 20:1D:0B:E9:15:35:E2:19

As you can see from the examples, the IPv6 keypad is also useful to input these strings.

### REFERENCES

[1] Wikipedia entry for IP version 4: http://en.wikipedia.org/wiki/IPv4
[2] Wikipedia entry for IP version 6: http://en.wikipedia.org/wiki/IPv6
[3] IPv6.org—The website dedicated to IPv6: http://www.ipv6.org/

1. A computer keypad that makes the input of IPv6 addresses and subnets as easy as inputting IPv4 addresses and subnets.

2. The keypad of claim 1 includes the extra characters which are required for IPv6, in addition to those used for IPv4 on the keypad. The additional characters required for IPv6 are (comma separated):
a, b, c, d, e, f, :

3. The complete list of characters on the keypad of claim 1 is (comma separated):
a, b, c, d, e, f, 0, 1, 2, 3, 4, 5, 6, 7, 8, 9, :, /, .
The period (.) is included for backwards compatibility with IPv4.

4. The keypad of claim 1 includes a key that enters two colons with one key press (::).

5. The keypad of claim 1 includes the tab and enter keys for ease of navigation within text files, software input screens or dialog boxes.

6. The keypad of claim 1 includes memory keys where IP related strings can be stored.

7. The keys mentioned in claims 4, 5 and 6 may not be included on some keypad models depending on usability studies and market demand.

8. The keypad of claim 1 has all keys close to each other so that IPv6 addresses and subnet masks can be entered easily with one hand.
